(19) United States
(12) Patent Application Publication
(10) Pub. No.: US 2003/0199725 A1
(43) Pub. Date: Oct. 23, 2003

(54) Method and device for detoxifying a polychlorinated biphenyl product

(76) Inventor: Yuji Kohara, Hiroshima (JP)

Correspondence Address: BIRCH STEWART KOLASCH & BIRCH, PO BOX 747, FALLS CHURCH, VA, 22040-0747, US

(21) Appl. No.: 10/192,521

(22) Filed: Jul. 11, 2002

(30) Foreign Application Priority Data
Apr. 22, 2002 (KR) 2002-21884

(51) Int. Cl. C25C 7/00; C02F 1/461

(52) U.S. Cl. 588/204; 205/688; 204/275.1; 204/165; 422/186.04

(57) ABSTRACT

A device for detoxifying waste polychlorinated biphenyl includes aluminum plates, insulating plates, copper pipe containing polychlorinated biphenyl powder and disposed on an upper side of the aligned aluminum and insulating plates, and a high voltage powder source for irradiating the copper pipe so as to produce unharmful hydrocarbon, and a method therefor.

### BACKGROUND OF THE INVENTION

1. Field of the Invention

The present invention relates to a device for detoxifying a polychlorinated biphenyl (hereafter “PCB”) product and method therefor, and more particularly, to a PCB rebirth device for effectively detoxifying waste PCB so as to recycle PCB in pollution free state, and method for the preparation thereof.

2. Description of Related Art

Various types of PCB rebirth devices and methods for the preparation thereof are known in the art. Recently, many people have tried to get cycled PCB product in a lot of studies. However, it is hard to get the recycled PCB from the waste PCB without pollution since several factors caused harm to the public have existed due to its poisonous character. Therefore, up to date, it is not succeeded to detoxify and recycle the waste PCB product without pollution.

Since plastics particularly, the PCB product possess electric insulation property, heat stability, lubricating oil, and stable chemical structure, the PCB product has utilized in a lot of industrial fields and can not decompose easily. Therefore, even though many methods for decomposing, treating and recycling the waste PCB have disclosed in this time, we can not expect a good result. For example, when the waste PCB is treated by a high heat burning method, an alkali catalystic method, and an ultraviolet decomposing method, a lot of dioxines generated by these methods cause harm to public and can destroy an ecosystem.

### SUMMARY OF THE INVENTION

Accordingly, it is an object of the present invention to provide an improved PCB detoxifying device and method for detoxifying thereof which eliminates the above problems encountered with conventional PCB detoxifying device and method for detoxifying thereof.

Another object of the present invention is to provide a PCB detoxifying device which includes a serpentine configured copper pipe disposed in a plurality of aluminum plates between a plurality of insulating plates for passing waste PCB product therewithin, so as to destroy the unioned elements thereof when high voltage electric current at the anode pole wire and the cathode pole wire is on. At this time, PCB transforms unharmful hydrocarbon such as light oil, gasoline, lamp oil, and kerosene.

A further object of the present invention is to provide an improved method for detoxifying of PCB product which comprises the steps of crushing waster PCB in a crusher, passing into a serpentine copper pipe with a stirring process, irritating with high voltage power current at the anode and cathode poles, and destroying the unioned structure thereof so as to transform from the waste PCB to unharmful hydrocarbon for producing gasoline and kerosene whereby the PCB detoxifying method is provided with a high yield and pollution free process.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view of a PCB detoxifying device according to the present invention;

### DETAILED DESCRIPTION OF THE PREFERRED EMBODIMENTS

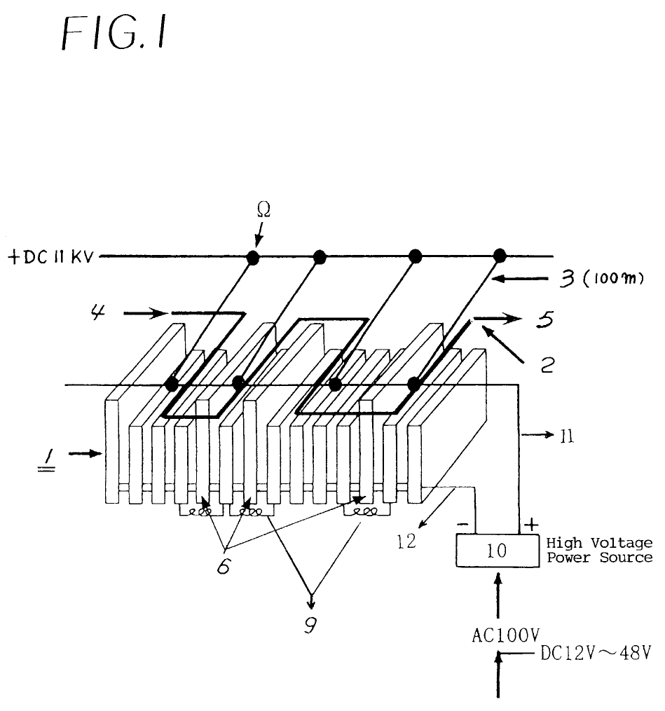

Referring now in detail to the drawings for the purpose of illustrating preferred embodiments of the present invention, the PCB detoxifying device as shown in FIG. 1 includes a plurality of aluminum plates 1, a plurality of insulating plates 6 disposed between the aluminum plates 1, a serpentine configurated copper pipe 2 having a PCB inlet 4 and a PCB outlet 5 disposed on both ends thereof for inducing and discharging PCB powder, and a direct current (hereinafter “DC”) wire 3 for being charged with high voltage electricity at an pole wire 11 and a cathode pole wire 12 of a high voltage power source 10.

At this time, the DC wire 3 having about DC 11 Kilovoltage connects to the anode pole wire 11 having AC 100 voltage of the high voltage source 10 and the cathode pole wire 12 has AC 100 voltage, so that the plurality of aluminum plates 1 are charged with high voltage electricity of the cathode pole wire 12 of the high voltage source 10. Both aluminum plates 1 disposed at both sides of the insulating plates 6 connect through an electric wire 9, respectively.

Accordingly, the molecular structure of the waste PCB product is destroyed by the anion of the high voltage electricity and the waste PCB product is transformed by cathode of the high voltage electricity. Because electric ion of the electricity irradiates PCB powder within the copper pipe 2 during mixing oxygen and air to PCB powder and irradiating the mixture in the copper pipe 2. Therefore, PCB is ionized as a cation, so that unioned elements are destroyed and the destroyed elements are fixed by anion while PCB is passed from the PCB inlet 4 to the PCB outlet 5 of the copper pipe 2. That is, the waste PCB product can be recycled without exit of any pollution materials.

The invention being this described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A device for detoxifying polychlorinated biphenyl comprising:
a plurality of aluminum plates;
a plurality of insulating plates disposed between said plurality of aluminum plates,
a copper pipe disposed on an upper side of said aligned aluminum and insulating plates, said copper pipe having an inlet and an outlet disposed at both ends thereof;
a direct current wire and an anode wire from a high voltage source being crossed on said upper side of the aligned aluminum and insulating plates, and
a cathode wire from said high voltage source being disposed a lower side of the aligned aluminum and insulating plates, whereby polychlorinated biphenyl powder from the inlet of the copper pipe passes through the copper pipe to the outlet of the copper pipe for transforming unharmful hydrocarbon to be recycled.

2. The device for detoxifying polychlorinated biphenyl of claim 1, wherein said direct current wire can be on a DC 11 Kilovoltage.

3. The device for detoxifying polychlorinated biphenyl of claim 1, wherein said anode and cathode wires can be on an AC 100 voltage.

4. The device for detoxifying polychlorinated biphenyl of claim 1, said both insulating plates surrounded the aluminum plate.

5. The device for detoxifying polychlorinated biphenyl of claim 1, wherein said copper pipe has a serpentine configuration.

6. A method for detoxifying polychlorinated biphenyl comprising the steps of:
(a) smashing and crushing waste polychlorinated biphenyl to produce smashed and crushed polychlorinated biphenyl powder;
(b) passing said smashed and crushed polychlorinated biphenyl powder and air through said copper pipe from an inlet thereof; and
(c) irritating and irradiating with high voltage electricity said copper pipe containing said smashed and crushed polychlorinated biphenyl powder to produce unharmful hydrocarbon from an outlet of the copper pipe.

7. The method for detoxifying polychlorinated biphenyl of claim 6, wherein said copper pipe has a serpentine configuration.

8. The method for detoxifying polychlorinated biphenyl of claim 6, wherein said high voltage electricity is a DC 11 kilovoltage wire and anode and cathode wire of an AC 100V high voltage power source.
